(19) United States
(12) Patent Application Publication
(10) Pub. No.: US 2026/0285317 A1
(43) Pub. Date: Sep. 24, 2026

(54) METHOD FOR CARRYING OUT AN AUTOMATED OVERTAKING MANEUVER OF A VEHICLE

(71) Applicant: MERCEDES-BENZ GROUP AG, Stuttgart (DE)

(72) Inventor: Eugen KÄFER, Renningen (DE)

(21) Appl. No.: 19/471,881

(22) PCT Filed: Feb. 23, 2024
(86) PCT No.: PCT/EP2024/054695

§ 371 Date: Oct. 2, 2025

(30) Foreign Application Priority Data
Apr. 3, 2023 (DE) 10 2023 001 323.4

(51) Int. Cl. B60W 30/18; B60W 60/00

(52) U.S. Cl. CPC B60W 30/18163; B60W 60/001; B60W 2554/4041; B60W 2554/802; B60W 2720/10

(57) ABSTRACT

When a vehicle plans an automated overtaking maneuver of another vehicle, detected signals of a surroundings sensor system are used to check whether other following vehicles within a rear sensor range of the surroundings sensor system are located in a lane of the vehicle and in an overtaking lane. If it is determined using the detected signals that, in relation to the sensor range, another following vehicle is located only in the lane of the vehicle, a current speed of travel of the vehicle is reduced by a specified speed value to let the other following vehicle overtake the vehicle and a vehicle driving in front of the vehicle. Once the other following vehicle has overtaken the vehicle, detected signals of the surroundings sensor system are used to check whether there is a clearance required for carrying out the overtaking maneuver in the overtaking lane.

### BACKGROUND AND SUMMARY OF THE INVENTION

Exemplary embodiments of the invention relate to a method for carrying out an automated overtaking maneuver of a vehicle, wherein other vehicles driving in an area surrounding the vehicle are detected.

DE 43 13 568 C1 discloses a method for assisting with guiding a motor vehicle for a lane change from a current lane to an adjacent target lane. In the method, a front space and a rear space of the adjacent lane for the desired lane change are monitored, the distances from objects detected there and the speeds thereof are measured, and safety distances are calculated therefrom. If all of the measured distances are greater than the calculated safety distances, this is recognized as being a lane change.

Moreover, DE 10 2020 118 664 A1 discloses a method for assisting a self-driving vehicle. The method determines whether it is possible for the self-driving vehicle to change lanes to an overtaking lane in order to pass an obstacle located in front of the self-driving vehicle on a roadway. If this is not the case, the self-driving vehicle stops before it reaches the obstacle and sends a request for assistance to a vehicle-external control center. The vehicle-external control center determines that there is a further vehicle in an area surrounding the self-driving vehicle and instructs the further vehicle to move in the direction of the self-driving vehicle and change to the overtaking lane before reaching the latter.

A method is known from WO 2022/189 716 A1 for assisting a driver of a vehicle during a manual lane change maneuver from a current lane to an overtaking lane. The method provides that when it is detected that the driver has activated the indicator to signal that they wish to perform the lane change maneuver, a collision risk is assessed and a warning is output to the driver if necessary. The collision risk assessment is based on determining relative accelerations of the vehicle with respect to other vehicles which are driving in front of the vehicle in the current lane or overtaking lane or are following the vehicle in these lanes.

A driver assistance method for a vehicle is known from DE 10 2017 203 867 A1, in which it is provided that another vehicle following the vehicle is detected by means of a camera and that by evaluating camera images, it is deduced that the following vehicle intends to overtake and the intention to overtake is signaled to the driver.

Exemplary embodiments invention are directed to a novel method for carrying out an overtaking maneuver for a self-driving vehicle.

A method for carrying out an automated overtaking maneuver of a vehicle, wherein other vehicles driving in an area surrounding the vehicle are detected, provides according to the invention that
in the event of an overtaking maneuver planned by the vehicle, detected signals of a surroundings sensor system are used to check whether other following vehicles within a rear sensor range of the surroundings sensor system are located in a lane of the vehicle and in an overtaking lane,
if it is determined using the detected signals that, in relation to the sensor range, another following vehicle is located only in the lane of the vehicle, a current speed of travel of the vehicle is reduced by a specified speed value to let the other following vehicle overtake the vehicle and a vehicle driving in front of the vehicle, and
once the other following vehicle has overtaken at least the vehicle, detected signals of the surroundings sensor system of the vehicle are used to check whether there is a clearance required for carrying out the overtaking maneuver in the overtaking lane.

By implementing the method, the other following vehicle is prompted to change to the overtaking lane and overtake the vehicle and a vehicle driving in front of it. As a result, the vehicle can carry out its planned overtaking maneuver without the risk of the following vehicle suddenly veering into the overtaking lane and the vehicle also starting to carry out the planned overtaking maneuver at this same point in time.

Since the vehicle reduces its current speed of travel by the specified speed value, in particular slightly, the other following vehicle is asked to perform an overtaking maneuver in order to overtake the vehicle and the vehicle driving in front. That is to say that the other following vehicle is no longer behind the vehicle, which means that a new situation exists that must be checked with regard to the planned overtaking maneuver.

Another embodiment of the method provides that if another following vehicle is detected in the overtaking lane within the sensor range, the overtaking maneuver of the vehicle is not initiated if a distance between the other following vehicle driving in the overtaking lane and the vehicle is less than a minimum clearance required for the other following vehicle to brake appropriately. In other words: if the sensor range is not large enough to detect the required minimum clearance, the overtaking maneuver of the vehicle is not authorized.

In particular, the overtaking maneuver of the vehicle is not initiated in this case, since the vehicle, when it overtakes the vehicle driving in front, represents a potential danger for the other following vehicle driving in the overtaking lane. In particular, the vehicle represents a potential danger for the other following vehicle in the overtaking lane if the vehicles are driving on a motorway without a speed limit and the other following vehicle driving in the overtaking lane is what is known as a high-speed vehicle that is currently driving at speed of at least 200 km/h. In order for the surroundings sensor system of the vehicle to detect such a high-speed other following vehicle, it requires a comparatively long sensor range, for example up to 260 m, but a surroundings sensor system with such a long sensor range is comparatively cost-intensive.

In one refinement, the required minimum clearance of the other vehicle driving in the overtaking lane is determined from a reaction distance, a braking distance, and a safety distance from the vehicle in the overtaking lane following braking carried out by the other following vehicle. If an unfavorable situation is assumed, wherein it is presumed that the other following vehicle is approaching at a possible speed of travel of over 200 km/h, the required minimum clearance that should be available to the vehicle to brake appropriately must be correspondingly large.

In one embodiment, if the other following vehicle driving in the overtaking lane is detected within the rear sensor range of the vehicle for a specified period of time, and it is detected in the overtaking lane that there is another specified safety distance between the vehicle and the vehicle that has already overtaken the vehicle, and there is a required further minimum clearance for the other following vehicle in the overtaking lane, the vehicle initiates its planned overtaking maneuver.

One possible refinement of the method provides that if the other following vehicle driving in the overtaking lane is detected within the rear sensor range of the vehicle for the specified period of time, the required minimum clearance for the vehicle is determined from a braking distance and a safety distance. That is to say that the reaction distance of the other following vehicle no longer needs to be taken into consideration, since the other following vehicle has already been following the overtaking other following vehicle at least for the specified period of time and a driver of the other following vehicle had at least the specified period of time to react to the overtaking other following vehicle by braking. The required further minimum clearance is then reduced by the reaction distance reduced and is accordingly shorter.

### BRIEF DESCRIPTION OF THE DRAWING FIGURES

Exemplary embodiments of the invention are explained in more detail hereinafter with reference to drawings, in which:

FIG. 1 schematically shows an illustration of a section of road and a traffic situation at a point in time and another illustration of a traffic situation on the section of road at a later point in time, and

FIG. 2 schematically shows an illustration of a section of road and a first traffic situation and another illustration of the section of road and a second traffic situation.

Mutually corresponding parts are given the same reference signs in all of the figures.

### DETAILED DESCRIPTION

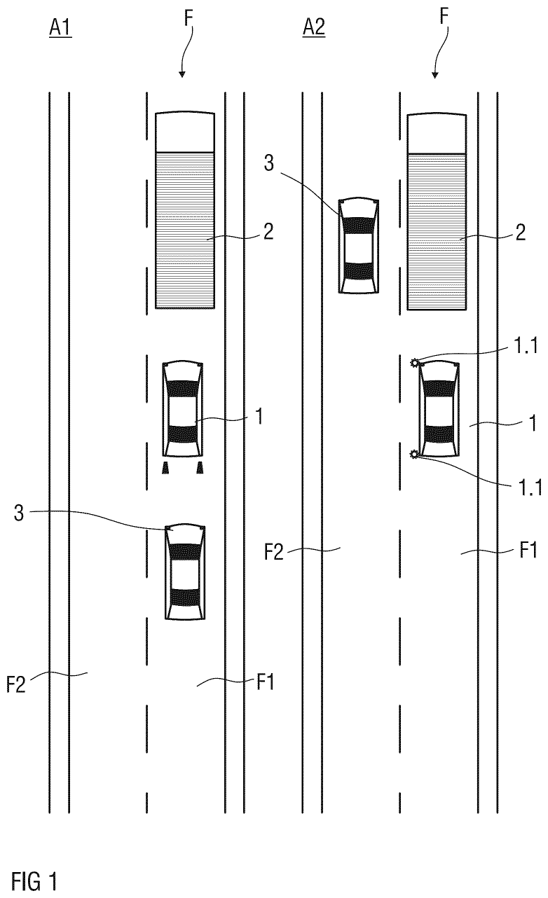

FIG. 1 shows two illustrations A1, A2 each with a section of road F that includes a right-hand lane F1 and an overtaking lane F2.

Driving in the lane F1 is a vehicle 1, a vehicle 2 driving in front of the latter and another vehicle 3 following the vehicle 1.

The vehicle 1 is driving in automated driving mode, in particular at Automation Level 3 or higher.

Level 3 describes a degree of automation in which a driving task is performed entirely by the vehicle 1, so that a driver of the vehicle 1 can deal with other tasks. As and when necessary, a take-over request is output in the vehicle 1, by means of which the driver is asked to take over the driving task.

At Driving Automation Level 4, the vehicle 1 is operated in highly automated mode, wherein the vehicle 1 continuously executes the driving task. If the vehicle 1 cannot handle a driving situation, the driver is asked to take over the task of driving.

A method for carrying out an automated overtaking maneuver of the vehicle 1 will be described hereinafter.

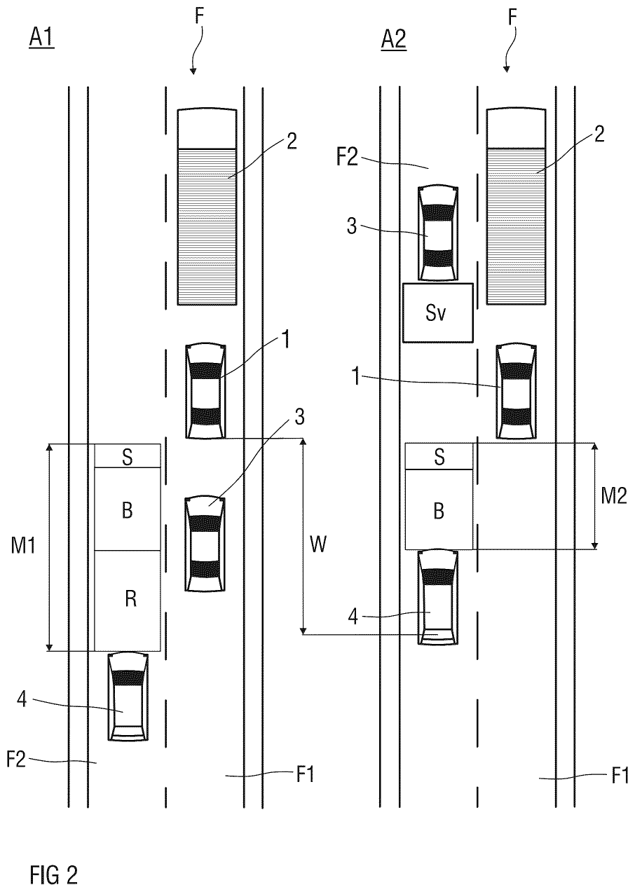

The vehicle 1 comprises a surroundings sensor system with a number of detection units (not shown in more detail) arranged in and/or on the vehicle 1 and continually detecting signals in the driving mode of the vehicle 1. The detected signals are used to detect an area surrounding the vehicle 1 and objects located therein within a sensor range W of the surroundings sensor system shown in FIG. 2.

In accordance with illustration A1 in FIG. 1, the vehicle 1 plans an overtaking maneuver, in order to overtake the vehicle 2—a lorry—driving in front. To carry out the overtaking maneuver it is determined using the detected signals of the surroundings sensor system of the vehicle 1 whether there is another following vehicle 3 in the lane F1 of the vehicle 1, behind the latter, and whether another following vehicle 4 shown in FIG. 2 is driving in the overtaking lane F.

If no other following vehicle 4 is detected in the overtaking lane F2 within the sensor range W of the surroundings sensor system of the vehicle 1, in particular in the rear space of the latter, and it is determined that another following vehicle 3 is driving behind the vehicle 1 in the lane F1, the vehicle 1 reduces its current speed of travel slightly by a specified speed value. As a result, the other following vehicle 3 is asked to change to the overtaking lane F2 and to overtake the vehicle 1 and the vehicle 2 driving in front, as shown in the second illustration A2 in FIG. 1.

Once the other following vehicle 3 has overtaken the vehicle 1, the latter again checks within the sensor range W its rear space in its lane F1 and the overtaking lane F2 to see whether there is enough of a clearance in the overtaking lane F2 for its planned overtaking maneuver. If it is determined using the detected signals of the surroundings sensor system that there is a sufficient clearance, the vehicle 1 activates its direction indicator 1.1 and starts to overtake the vehicle 2 driving in front. In particular, the overtaking maneuver is carried out in an automated manner.

An illustration A1 in FIG. 2 shows a first traffic situation on a section of road F with a right-hand lane F1 and an overtaking lane F2.

Here as well, the vehicle 1 is driving in automated driving mode at Automation Level 3 or higher.

Driving in lane F1 is the vehicle 1, a vehicle 2 driving in front of the latter and another vehicle 3 following the vehicle 1. Driving in the overtaking lane F2 is another following vehicle 4, which is located outside the sensor range W of the surroundings sensor system of the vehicle 1 and is thus not detected by the latter.

The vehicle 1 plans an overtaking maneuver in order to overtake the vehicle 2 driving in front, in particular a lorry.

In order to carry out the overtaking maneuver of the vehicle 1, it is necessary to detect all of the other following vehicles 4 in the overtaking lane F2 that might be put in danger by the overtaking maneuver of the vehicle 1.

In particular, the vehicle 1 carrying out the overtaking maneuver presents a danger for other following vehicles 4 in the overtaking lane F2 if the other vehicle 4 driving in the overtaking lane F2 can no longer safely avoid a collision with the vehicle 1 by braking appropriately.

This is particularly the case if a distance between the other following vehicle 4 in the overtaking lane F2 and the vehicle 1 is less than a minimum clearance M1 required by the other following vehicle 4 to brake appropriately

In particular, it is necessary to define the required minimum distance M1 when designing an automated driving system for the vehicle 1. It must be assumed here that in the worst case the other following vehicle 4 is driving at the maximum speed possible specified for the system design, for example 250 km/h on a section of motorway without a speed limit, and it will brake at most with a specified appropriate deceleration of, for example, 6 m/s².

The required minimum clearance M1 is made up of a reaction distance R, a braking distance B, and a safety distance S.

The reaction distance R is specified by a distance that the other following vehicle 4 covers within a specified reaction time of, for example, 1 s. A possible maximum speed of, for example, 250 km/h and a reaction time of 1 s results by way of example in a reaction distance of 70 m.

The braking distance B describes a distance needed to decelerate the other following vehicle 4 driving in the overtaking lane F2 to the current speed of travel of the vehicle 1.

The safety distance S in this case is a distance that should remain as a safety reserve between the vehicle 1 and the other following vehicle 4 after the latter has braked in the overtaking lane F2 between the latter and the vehicle 1.

In order to authorize the planned overtaking maneuver of the vehicle 1 in accordance with the first traffic situation shown in the illustration A1, it is possible to recognize, i.e., to determine, whether there is the required minimum clearance M1. In other words, if the sensor range W of the surroundings sensor system is not large enough to be able to recognize the required minimum clearance M1, then the planned overtaking maneuver of the vehicle 1 cannot be authorized.

This is the case in accordance with the first traffic situation shown in FIG. 2 in illustration A1, and the vehicle is not designed to execute its planned overtaking maneuver in this case due to its system design.

In accordance with the second traffic situation shown in FIG. 2 in the other illustration A2, the other following vehicle 3 has overtaken the vehicle 1 and is driving level with the vehicle 2 that is driving in front of the vehicle 1 in the lane F1.

The other following vehicle 4 driving in the overtaking lane F2 has been following the overtaking other following vehicle 3 for a specified period of time, in particular of several seconds, and has therefore been able to react to the other following vehicle 3 early, in particular by reducing its speed of travel.

There is sufficient clearance in front of the vehicle 1 for it to carrying out its planned overtaking maneuver, i.e., there is a safety distance Sv.

There is a sufficiently large clearance to the rear, which is made up as other minimum clearance M2 of the braking distance B and the safety distance S. Here, the reaction distance R is therefore no longer taken into consideration, since the other following vehicle 4 has been following the overtaking other following vehicle 3 for several seconds. As a result, a driver of the other following vehicle 4 has enough time to react to the overtaking other following vehicle 3 by braking. The reaction time has thus elapsed and therefore the reaction distance R no longer needs to be taken into account.

If, as described further above, the worst case scenario is assumed in which the other following vehicle 4 is driving at a conceivable maximum speed of 250 km/h and the reaction time is 1 s, the reaction distance R is 70 m long. Since the reaction distance R is not taken into consideration in relation to the second traffic situation in the other illustration A2, the further minimum clearance M2 is 70 m less than the minimum clearance M1 according to the first traffic situation shown in illustration A1.

In the second traffic situation described in the other illustration A2, the sensor range W in relation to the rear space of the vehicle 1 is large enough to recognize the reduced further minimum clearance M2.

The vehicle 1 can thus recognize in accordance with the second traffic situation whether there is a sufficiently large clearance behind it for its overtaking maneuver and can then authorize the automated overtaking maneuver.

In accordance with the first traffic situation shown in the illustration A1, it is not technically possible for the vehicle 1 to check the prerequisites for authorizing the overtaking maneuver owing to the restricted sensor range W.

By contrast, in the second traffic situation shown in the other illustration A2, it is technically possible for the vehicle 1 to check the prerequisites for authorizing the planned overtaking maneuver.

Therefore it is expedient for the vehicle 1 and its driving strategy to transition from the first traffic situation into the second traffic situation. To this end, it can initially be checked whether a current situation corresponds to the first traffic situation. If this is the case, measures are initiated to transition the current situation into the second traffic situation. To this end, the vehicle 1 reduces its current speed of travel, in particular by braking comparatively gently, to let the other following vehicle 3 overtake the vehicle 1 and the vehicle 2 driving in front.

In the event of the second traffic situation, the vehicle 1 can then check whether there is enough clearance for it to carry out its planned overtaking maneuver and, if appropriate, carry out the overtaking maneuver.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-5. (canceled)

6. A method for a vehicle carrying out an automated overtaking maneuver of a leading vehicle, the method comprising:
detecting, by a surroundings sensor system of the vehicle, other vehicles driving in an area surrounding the vehicle, wherein the other vehicles include other following vehicles;
planning, by the vehicle, the automated overtaking maneuver of the leading vehicle by
checking, by the vehicle, whether the other following vehicles, which are within a rear sensor range of the surroundings sensor system, are located in a lane of the vehicle and in an overtaking lane;
reducing, by the vehicle responsive to the checking indicating that at least one of the other following vehicles is only located in a same lane as the vehicle, a current speed of travel of the vehicle by a specified speed value to allow the at least one of the other following vehicles to overtake the vehicle and the leading vehicle; and
checking, by the vehicle using the surroundings sensor system and after the at least one of the other following vehicles has overtaken the vehicle, whether there is a clearance in the overtaking lane for the vehicle to perform the automated overtaking maneuver.

7. The method of claim 6, wherein when another one of the following vehicles is detected in the overtaking lane within the sensor range, the overtaking maneuver of the vehicle is not initiated when a distance between the another one of the following vehicles driving in the overtaking lane and the vehicle is less than a minimum clearance required for the another one of the following vehicles to brake appropriately.

8. The method of claim 7, wherein the required minimum clearance of the another one of the following vehicles (4) driving in the overtaking lane is determined from a reaction distance, a braking distance, and a safety distance from the vehicle in the overtaking lane following braking carried out by the another one of the following vehicles.

9. The method of claim 8, wherein the vehicle initiates the planned automated overtaking maneuver when the another one of following vehicles driving in the overtaking lane is detected within the rear sensor range of the vehicle for a specified period of time and it is detected in the overtaking lane that there is a specified further safety distance between the vehicle and the at least one of the other following vehicles that has already overtaken the vehicle, and there is a required further minimum clearance for the another one of the following vehicles in the overtaking lane.

10. The method of claim 9, wherein when the another one of the following vehicles driving in the overtaking lane is detected within the rear sensor range of the vehicle for the specified period of time, the required further minimum clearance for the other following vehicle in the overtaking lane is determined from a braking distance and a safety distance.
